(19) United States
(12) Patent Application Publication
(10) Pub. No.: US 2018/0165863 A1
(43) Pub. Date: Jun. 14, 2018

(54) INFORMATION PROCESSING METHOD, DEVICE, AND PROGRAM FOR EXECUTING THE INFORMATION PROCESSING METHOD ON A COMPUTER

(71) Applicant: COLOPL, Inc., Tokyo (JP)

(72) Inventors: Norihiro KUBO, Kanagawa (JP); Atsushi INOMATA, Kanagawa (JP); Satoshi KIMURA, Kanagawa (JP); Seiji SATAKE, Tokyo (JP)

(21) Appl. No.: 15/834,027

(22) Filed: Dec. 6, 2017

(30) Foreign Application Priority Data
Dec. 6, 2016 (JP) 2016-236776

(51) Int. Cl. G06T 13/40; G06K 9/00; G06F 3/01; G10L 25/63

(52) U.S. Cl. CPC G06T 13/40; G10L 25/63; G06F 3/012; G06K 9/00315

(57) ABSTRACT

[Object] To facilitate emotional understanding among a plurality of users in a virtual experience in which a virtual space is shared by the users.

[Solving Means] Provided is an information processing method for providing a first user with a virtual space via a first head-mounted display, the information processing method including the steps of: generating virtual space data for defining a virtual space including a first avatar object associated with the first user, a second avatar object associated with a second user, and a virtual camera for defining a field-of-view image to be provided to the first head-mounted display; identifying an emotion of the second user; determining an effect image to be displayed in association with the second avatar object in the field-of-view image based on the emotion of the second user; and arranging the effect image in the field-of-view image.

### TECHNICAL FIELD

This disclosure relates to an information processing method, a device, and a program for executing the information processing method on a computer.

### BACKGROUND ART

In Non-Patent Document 1, there is disclosed a technology for operating, in a virtual space shared by a plurality of users, an avatar (player character) associated with each user based on an operation by each user. With this technology, it is possible to provide the plurality of users with chat (hereinafter referred to as “VR chat”) capabilities in the shared virtual space.

### RELATED ART

### Non-Patent Documents

[Non-Patent Document 1] “Facebook Mark Zuckerberg Social VR Demo OC3 Oculus Connect 3 Keynote”, [online], Oct. 6, 2016, VRvibe, [retrieved on Dec. 5, 2016], Internet <https://www.youtube.com/watch?v=NCpNKLXovtE>

### SUMMARY

### Means for Solving the Problem

According to one embodiment of this disclosure, there is provided an information processing method to be executed by a computer to provide a first user with a virtual space via a first head-mounted display. This information processing method includes the steps of: generating virtual space data for defining a virtual space including a first avatar object associated with the first user, a second avatar object associated with a second user, and a virtual camera for defining a field-of-view image to be provided to the first head-mounted display; identifying an emotion of the second user; and determining an effect image to be displayed in association with the second avatar object in the field-of-view image based on the identified emotion of the second user.

### BRIEF DESCRIPTION OF THE DRAWINGS

FIG. 1 A diagram for illustrating an overview of a configuration of an HMD system in one embodiment of this disclosure.

FIG. 2 A block diagram for illustrating an example of a hardware configuration of a computer in one embodiment of this disclosure.

FIG. 3 A diagram for schematically illustrating a uvw visual-field coordinate system to be set for an HMD in one embodiment of this disclosure.

FIG. 4 A diagram for schematically illustrating one mode of expressing a virtual space in one embodiment of this disclosure.

FIG. 5 A diagram for illustrating, from above, a head of a user wearing the HMD in one embodiment of this disclosure.

FIG. 6 A diagram for illustrating a YZ cross section obtained by viewing a field-of-view region from an X direction in the virtual space.

FIG. 7 A diagram for illustrating an XZ cross section obtained by viewing the field-of-view region from a Y direction in the virtual space.

FIG. 8 Diagrams for illustrating a schematic configuration of a controller in one embodiment of this disclosure.

FIG. 9 A block diagram for illustrating an example of a hardware configuration of a server in one embodiment of this disclosure.

FIG. 10 A block diagram for illustrating a computer in one embodiment of this disclosure in terms of its module configuration.

FIG. 11 A sequence chart for illustrating a part of processing to be executed by an HMD set in one embodiment of this disclosure.

FIG. 12 Schematic diagrams for illustrating a situation in which each HMD provides the user with the virtual space in a network.

FIG. 13 A sequence diagram for illustrating processing to be executed by the HMD system in one embodiment of this disclosure.

FIG. 14 A block diagram for illustrating a detailed configuration of modules of the computer in one embodiment of this disclosure.

FIG. 15 A diagram for schematically illustrating a virtual space shared by a plurality of users.

FIG. 16 A diagram for illustrating a field-of-view image to be provided to the user.

FIG. 17 A sequence diagram for illustrating processing to be executed by the HMD system and the server.

FIG. 18 A flowchart for illustrating processing to be executed by the HMD system in a first example of effect control.

FIG. 19 A diagram for illustrating an example of the field-of-view image to be generated by the first example of effect control.

FIG. 20 A flowchart for illustrating processing to be executed by the HMD system in a second example of effect control.

FIG. 21 A diagram for illustrating an example of the field-of-view image to be generated by the second example of effect control.

FIG. 22 A diagram for illustrating another example of the field-of-view image to be generated by the second example of effect control.

### DESCRIPTION OF EMBODIMENTS

Now, with reference to the drawings, embodiments of this technical idea are described in detail. In the following description, like components are denoted by like reference symbols. The same applies to the names and functions of those components. Therefore, detailed description of those components is not repeated. The embodiments described below may be appropriately combined with one another in a selective manner.

[Configuration of HMD System]

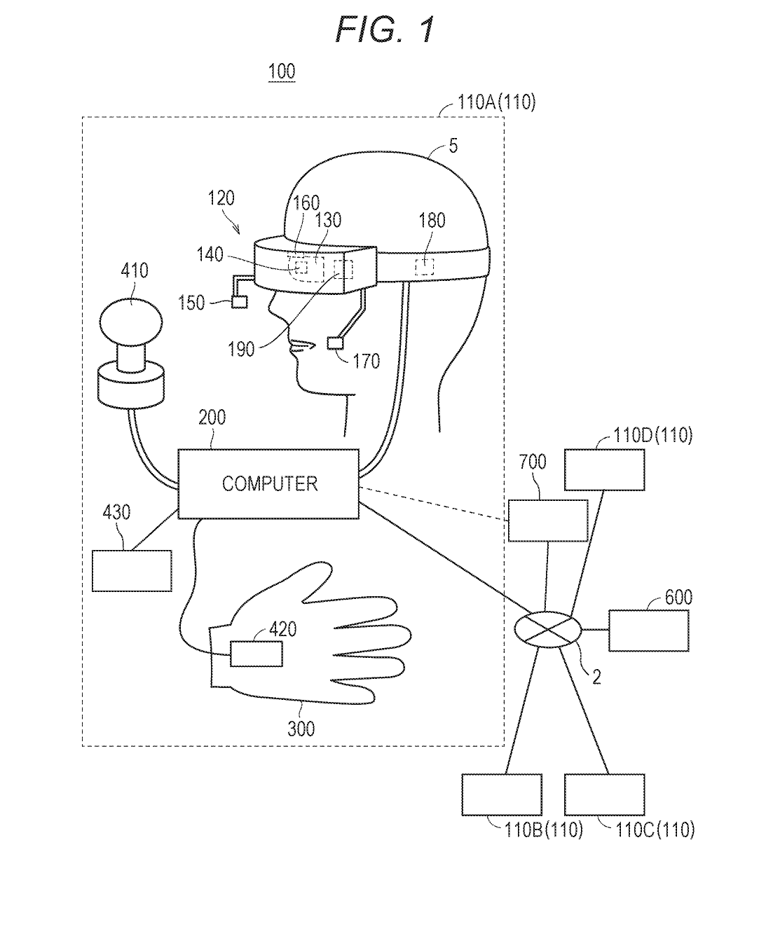

With reference to FIG. 1, a configuration of a head-mounted device (HMD) system 100 is described. FIG. 1 is a diagram for illustrating an overview of the configuration of the HMD system 100 in one embodiment of this disclosure. The HMD system 100 is provided as a system for household use or a system for professional use.

The HMD system 100 includes a server 600, HMD sets 110A, 110B, 110C, and 110D, an external device 700, and a network 2. Each of the HMD sets 110A, 110B, 110C, and 110D is capable of communicating to/from the server 600 or the external device 700 via the network 2. In the following, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. The controller 300 may include a motion sensor 420.

In one aspect, the computer 200 can be connected to the network 2, for example, the Internet, and can communicate to/from the server 600 or other computers connected to the network 2. Examples of the other computers include a computer of another HMD set 110 and the external device 700. In another aspect, the HMD 120 may include a sensor 190 instead of the HMD sensor 410.

The HMD 120 may be worn on a head of a user 5 to provide a virtual space to the user 5 during operation. More specifically, the HMD 120 displays each of a right-eye image and a left-eye image on the monitor 130. When each eye of the user 5 visually recognizes each image, the user 5 may recognize the image as a three-dimensional image based on the parallax of both the eyes. The HMD 120 may include any one of a so-called head-mounted display including a monitor and a head-mounted device capable of mounting a smartphone or other terminals including a monitor.

The monitor 130 is implemented as, for example, a non-transmissive display device. In one aspect, the monitor 130 is arranged on a main body of the HMD 120 so as to be positioned in front of both the eyes of the user 5. Therefore, when the user 5 visually recognizes the three-dimensional image displayed on the monitor 130, the user 5 can be immersed in the virtual space. In one aspect, the virtual space includes, for example, a background, objects that can be operated by the user 5, and menu images that can be selected by the user 5. In one aspect, the monitor 130 may be implemented as a liquid crystal monitor or an organic electroluminescence (EL) monitor included in a so-called smartphone or other information display terminals.

In another aspect, the monitor 130 may be implemented as a transmissive display device. In this case, the HMD 120 is not a non-see-through HMD covering the eyes of the user 5 illustrated in FIG. 1, but may be a see-through HMD, for example, smartglasses. The transmissive monitor 130 may be configured as a temporarily non-transmissive display device through adjustment of a transmittance thereof. The monitor 130 may be configured to display a real space and a part of an image constructing the virtual space at the same time. For example, the monitor 130 may display an image of the real space captured by a camera mounted on the HMD 120, or may enable recognition of the real space by setting the transmittance of a part the monitor 130 high.

In one aspect, the monitor 130 may include a sub-monitor for displaying a right-eye image and a sub-monitor for displaying a left-eye image. In another aspect, the monitor 130 may be configured to integrally display the right-eye image and the left-eye image. In this case, the monitor 130 includes a high-speed shutter. The high-speed shutter operates so as to enable alternate display of the right-eye image and the left-eye image so that only one of the eyes can recognize the image.

In one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In another aspect, the HMD sensor 410 may be implemented by a camera. In this case, the HMD sensor 410 may use image information of the HMD 120 output from the camera to execute image analysis processing, to thereby enable detection of the position and the inclination of the HMD 120.

In another aspect, the HMD 120 may include the sensor 190 instead of, or in addition to, the HMD sensor 410 as a position detector. The HMD 120 may use the sensor 190 to detect the position and the inclination of the HMD 120 itself. For example, when the sensor 190 is an angular velocity sensor, a geomagnetic sensor, or an acceleration sensor, the HMD 120 may use any of those sensors instead of the HMD sensor 410 to detect the position and the inclination of the HMD 120 itself. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In one aspect, the eye gaze sensor 140 is preferred to include a right-eye sensor and a left-eye sensor. The eye gaze sensor 140 may be, for example, a sensor configured to irradiate the right eye and the left eye of the user 5 with an infrared ray, and to receive reflection light from the cornea and the iris with respect to the irradiation light, to thereby detect a rotational angle of each eyeball. The eye gaze sensor 140 can detect the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In one aspect, the first camera 150 may be arranged outside of the HMD 120, and the second camera 160 may be arranged inside of the HMD 120. Images generated by the first camera 150 and the second camera 160 are input to the computer 200. In another aspect, the first camera 150 and the second camera 160 may be implemented as one camera, and the face of the user 5 may be photographed with this one camera.

The microphone 170 converts an utterance of the user 5 into a voice signal (electric signal) for output to the computer 200. The speaker 180 converts the voice signal into a voice for output to the user 5. In another aspect, the HMD 120 may include earphones in place of the speaker 180.

The controller 300 is connected to the computer 200 through wired or wireless communication. The controller 300 receives input of a command from the user 5 to the computer 200. In one aspect, the controller 300 can be held by the user 5. In another aspect, the controller 300 can be mounted to the body or a part of the clothes of the user 5. In still another aspect, the controller 300 may be configured to output at least any one of a vibration, a sound, or light based on the signal transmitted from the computer 200. In yet another aspect, the controller 300 receives from the user 5 an operation for controlling the position and the motion of an object arranged in the virtual space.

In one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In another aspect, the HMD sensor 410 may be implemented by a camera. In this case, the HMD sensor 410 may use image information of the controller 300 output from the camera to execute image analysis processing, to thereby enable detection of the position and the inclination of the controller 300.

In one aspect, the motion sensor 420 is mounted on the hand of the user 5 to detect the motion of the hand of the user 5. For example, the motion sensor 420 detects a rotational speed and the number of rotations of the hand. The detected signal is transmitted to the computer 200. The motion sensor 420 is provided to, for example, the controller 300. In one aspect, the motion sensor 420 is provided to, for example, the controller 300 capable of being held by the user 5. In another aspect, for the safety in the real space, the controller 300 is mounted on an object like a glove-type object that does not easily fly away by being worn on a hand of the user 5. In still another aspect, a sensor that is not mounted on the user 5 may detect the motion of the hand of the user 5. For example, a signal of a camera that photographs the user 5 may be input to the computer 200 as a signal representing the motion of the user 5. As one example, the motion sensor 420 and the computer 200 are connected to each other through wireless communication. In the case of wireless communication, the communication mode is not particularly limited, and for example, Bluetooth (trademark) or other known communication methods are used.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

The server 600 may transmit a program to the computer 200. In another aspect, the server 600 may communicate to/from another computer 200 for providing virtual reality to the HMD 120 used by another user. For example, when a plurality of users play a participatory game in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 may be any device as long as the external device 700 can communicate to/from the computer 200. The external device 700 may be, for example, a device capable of communicating to/from the computer 200 via the network 2, or may be a device capable of directly communicating to/from the computer 200 by near field communication or wired communication. Peripheral devices such as a smart device, a personal computer (PC), and the computer 200 may be used as the external device 700, but the external device 700 is not limited thereto.

[Hardware Configuration of Computer]

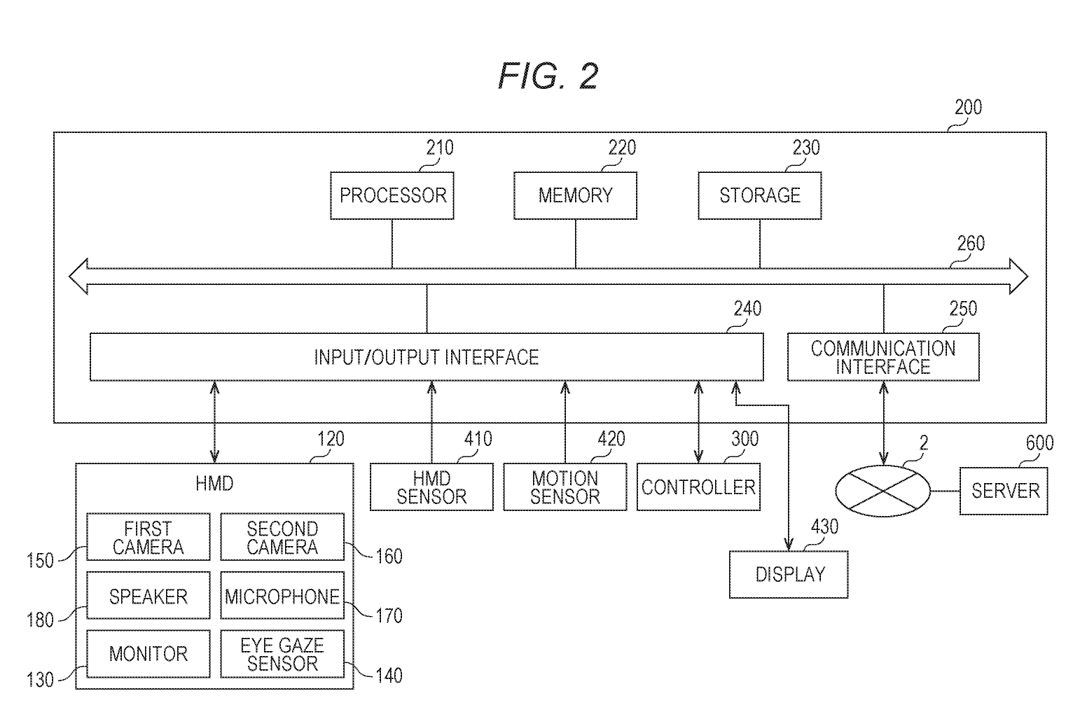

With reference to FIG. 2, the computer 200 in this embodiment is described. FIG. 2 is a block diagram for illustrating an example of the hardware configuration of the computer 200 in this embodiment. The computer 200 includes, as primary components, a processor 210, a memory 220, a storage 230, an input/output interface 240, and a communication interface 250. Each component is connected to a bus 260.

The processor 210 executes a series of commands included in a program stored in the memory 220 or the storage 230 based on a signal transmitted to the computer 200 or on satisfaction of a condition determined in advance. In one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In one aspect, the memory 220 is implemented as a random access memory (RAM) or other volatile memories.

The storage 230 permanently stores programs and data. The storage 230 is implemented as, for example, a read-only memory (ROM), a hard disk device, a flash memory, or other non-volatile storage devices. The programs stored in the storage 230 include programs for providing a virtual space in the HMD system 100, simulation programs, game programs, user authentication programs, and programs for implementing communication to/from other computers 200. The data stored in the storage 230 includes data and objects for defining the virtual space.

In another aspect, the storage 230 may be implemented as a removable storage device like a memory card. In still another aspect, a configuration that uses programs and data stored in an external storage device may be used instead of the storage 230 built into the computer 200. With such a configuration, for example, in a situation in which a plurality of HMD systems 100 are used as in an amusement facility, the programs and the data can be collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In one aspect, the input/output interface 240 is implemented with use of a universal serial bus (USB), a digital visual interface (DVI), a high-definition multimedia interface (HDMI) (trademark), or other terminals. The input/output interface 240 is not limited to ones described above.

In one aspect, the input/output interface 240 may further communicate to/from the controller 300. For example, the input/output interface 240 receives input of a signal output from the controller 300 and the motion sensor 420. In another aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In one aspect, the communication interface 250 is implemented as, for example, a local area network (LAN), other wired communication interfaces, wireless fidelity (Wi-Fi), Bluetooth (trademark), near field communication (NFC), or other wireless communication interfaces. The communication interface 250 is not limited to ones described above.

In one aspect, the processor 210 accesses the storage 230 and loads one or more programs stored in the storage 230 to the memory 220 to execute a series of commands included in the program. The one or more programs may include an operating system of the computer 200, an application program for providing a virtual space, and game software that can be executed in the virtual space. The processor 210 transmits a signal for providing a virtual space to the HMD 120 via the input/output interface 240. The HMD 120 displays a video on the monitor 130 based on the signal.

In the example illustrated in FIG. 2, the computer 200 is provided outside of the HMD 120, but in another aspect, the computer 200 may be built into the HMD 120. As an example, a portable information communication terminal (e.g., smartphone) including the monitor 130 may function as the computer 200.

The computer 200 may be used in common among a plurality of HMDs 120. With such a configuration, for example, the same virtual space can be provided to a plurality of users, and hence each user can enjoy the same application with other users in the same virtual space.

According to one embodiment of this disclosure, in the HMD system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which correspond to the motion of the user 5 wearing the HMD 120, based on the value of each point (each coordinate value in the real coordinate system). In more detail, the HMD sensor 410 can detect the temporal change of the position and the inclination of the HMD 120 with use of each value detected over time.

Each inclination of the HMD 120 detected by the HMD sensor 410 corresponds to each inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

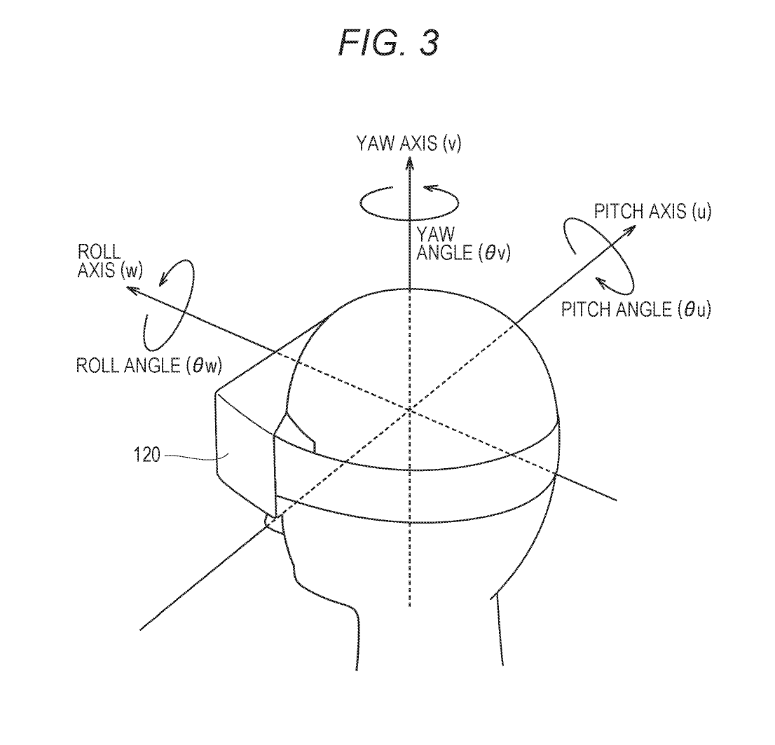

With reference to FIG. 3, the uvw visual-field coordinate system is described. FIG. 3 is a diagram for schematically illustrating a uvw visual-field coordinate system to be set for the HMD 120 in one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

As illustrated in FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In one aspect, when the user 5 wearing the HMD 120 is standing upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 can detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is always constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In one aspect, the HMD sensor 410 may identify the position of the HMD 120 in the real space as a position relative to the HMD sensor 410 based on the light intensity of the infrared ray or a relative positional relationship between a plurality of points (e.g., distance between points), which is acquired based on output from the infrared sensor. The processor 210 may determine the origin of the uvw visual-field coordinate system of the HMD 120 in the real space (real coordinate system) based on the identified relative position.

[Virtual Space]

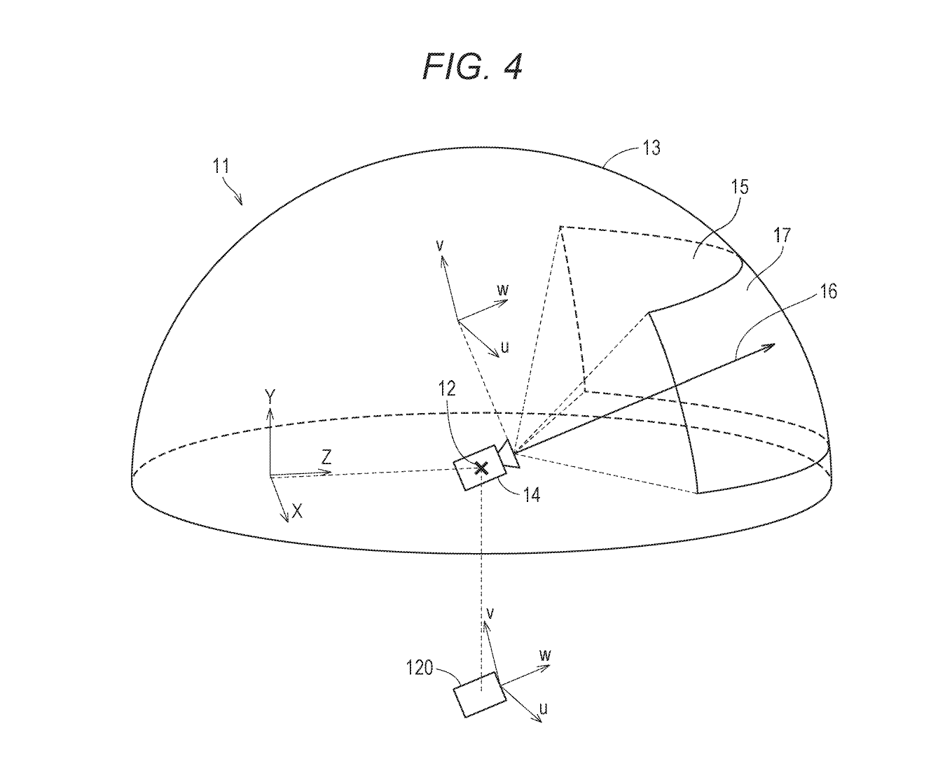

With reference to FIG. 4, the virtual space is further described. FIG. 4 is a diagram for schematically illustrating one mode of expressing a virtual space 11 in one embodiment of this disclosure. The virtual space 11 has a structure with an entire celestial sphere shape covering a center 12 in all 360-degree directions. In FIG. 4, in order to avoid complicated description, only the upper-half celestial sphere of the virtual space 11 is exemplified. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that can be developed in the virtual space 11 with each corresponding mesh section in the virtual space 11.

In one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space may be reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 can be said to be a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the HMD system 100 in one aspect, the line of sight of the user 5 detected by the eye gaze sensor 140 can be regarded as the line of sight of the user 5 in the uvw visual-field coordinate system of the virtual camera 14.

[User's Line of Sight]

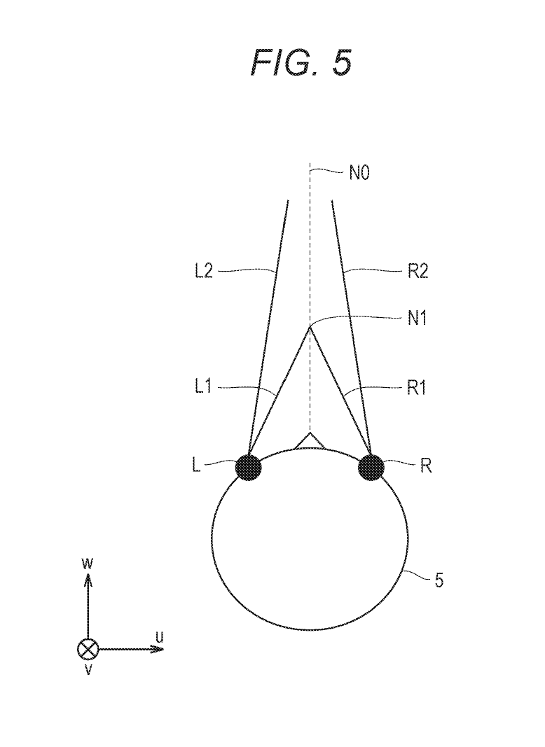

With reference to FIG. 5, determination of the line of sight of the user 5 is described. FIG. 5 is a diagram for illustrating, from above, the head of the user 5 wearing the HMD 120 in one embodiment of this disclosure.

In one aspect, the eye gaze sensor 140 detects lines of sight of the right eye and the left eye of the user 5. In one aspect, when the user 5 is looking at a near place, the eye gaze sensor 140 detects lines of sight R1 and L1. In another aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight N0 of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight N0. The line of sight N0 is a direction in which the user 5 actually directs his or her lines of sight with both eyes. The line of sight N0 corresponds to a direction in which the user 5 actually directs his or her lines of sight with respect to the field-of-view region 15.

In another aspect, the HMD system 100 may include a television broadcast reception tuner. With such a configuration, the HMD system 100 can display a television program in the virtual space 11.

In still another aspect, the HMD system 100 may include a communication circuit for connecting to the Internet or have a verbal communication function for connecting to a telephone line.

[Field-of-View Region]

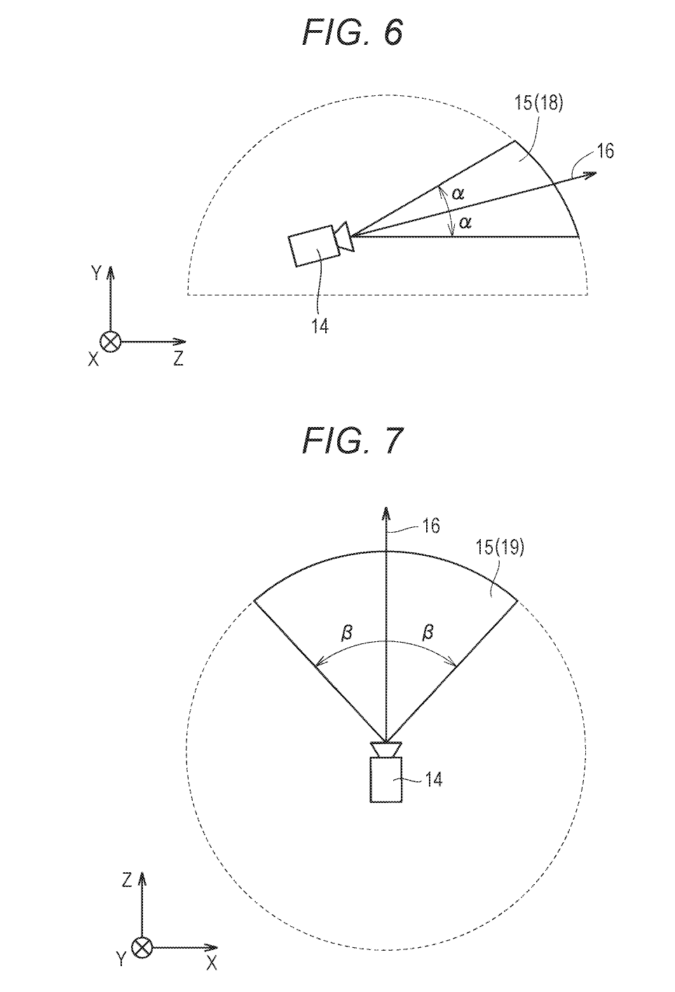

With reference to FIG. 6 and FIG. 7, the field-of-view region 15 is described. FIG. 6 is a diagram for illustrating a YZ cross section obtained by viewing the field-of-view region 15 from an X direction in the virtual space 11. FIG. 7 is a diagram for illustrating an XZ cross section obtained by viewing the field-of-view region 15 from a Y direction in the virtual space 11.

As illustrated in FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

As illustrated in FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 14 and the inclination (direction) of the virtual camera 14.

In one aspect, the HMD system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120, the user 5 can visually recognize only the panorama image 13 developed in the virtual space 11 without visually recognizing the real world. Therefore, the HMD system 100 can provide a high sense of immersion in the virtual space 11 to the user 5.

In one aspect, the processor 210 may move the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In one aspect, the virtual camera 14 may include two virtual cameras, that is, a virtual camera for providing a right-eye image and a virtual camera for providing a left-eye image. An appropriate parallax is set for the two virtual cameras so that the user 5 can recognize the three-dimensional virtual space 11. In another aspect, the virtual camera 14 may be implemented by one virtual camera. In this case, a right-eye image and a left-eye image may be generated from an image acquired by one virtual camera. In this embodiment, the technical idea of this disclosure is exemplified assuming that the virtual camera 14 includes two virtual cameras, and the roll axes of the two virtual cameras are synthesized so that the generated roll axis (w) is adapted to the roll axis (w) of the HMD 120.

[Controller]

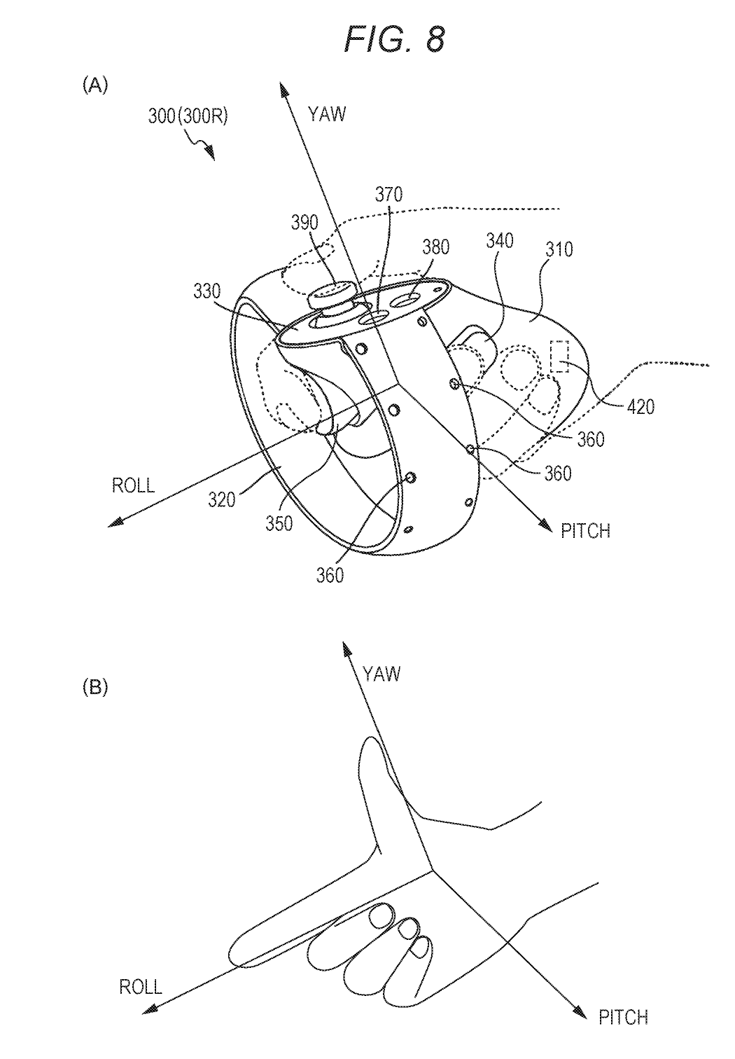

An example of the controller 300 is described with reference to FIG. 8. FIG. 8 are diagrams for illustrating a schematic configuration of the controller 300 in one embodiment of this disclosure.

As illustrated in FIG. 8, in one aspect, the controller 300 may include a right controller 300R and a left controller (not shown). The right controller 300R is operated by the right hand of the user 5. The left controller is operated by the left hand of the user 5. In one aspect, the right controller 300R and the left controller are symmetrically configured as separate devices. Therefore, the user 5 can freely move his or her right hand holding the right controller 300R and his or her left hand holding the left controller. In another aspect, the controller 300 may be an integrated controller configured to receive an operation performed by both hands. The right controller 300R is now described.

The right controller 300R includes a grip 310, a frame 320, and a top surface 330. The grip 310 is configured so as to be held by the right hand of the user 5. For example, the grip 310 may be held by the palm and three fingers (middle finger, ring finger, and small finger) of the right hand of the user 5.

The grip 310 includes buttons 340 and 350 and the motion sensor 420. The button 340 is arranged on a side surface of the grip 310, and receives an operation performed by the middle finger of the right hand. The button 350 is arranged on a front surface of the grip 310, and receives an operation performed by the index finger of the right hand. In one aspect, the buttons 340 and 350 are configured as trigger type buttons. The motion sensor 420 is built into the casing of the grip 310. When a motion of the user 5 can be detected from the surroundings of the user 5 by a camera or other device, it is not required for the grip 310 to include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 may be used to detect the position and the posture (inclination and direction) of each of the right controller 300R and the left controller. In the example illustrated in FIG. 8, the infrared LEDs 360 are shown as being arranged in two rows, but the number of arrangement rows is not limited to that illustrated in FIG. 8. The infrared LEDs 360 may be arranged in one row or in three or more rows.

The top surface 330 includes buttons 370 and 380 and an analog stick 390. The buttons 370 and 380 are configured as push type buttons. The buttons 370 and 380 receive an operation performed by the thumb of the right hand of the user 5. In one aspect, the analog stick 390 receives an operation performed in any direction of 360 degrees from an initial position (neutral position). The operation includes, for example, an operation for moving an object arranged in the virtual space 11.

In one aspect, each of the right controller 300R and the left controller includes a battery for driving the infrared ray LEDs 360 and other members. The battery includes, for example, a rechargeable battery, a button battery, a dry battery, but the battery is not limited thereto. In another aspect, the right controller 300R and the left controller may be connected to, for example, a USB interface of the computer 200. In this case, the right controller 300R and the left controller do not require a battery.

[Hardware Configuration of Server]

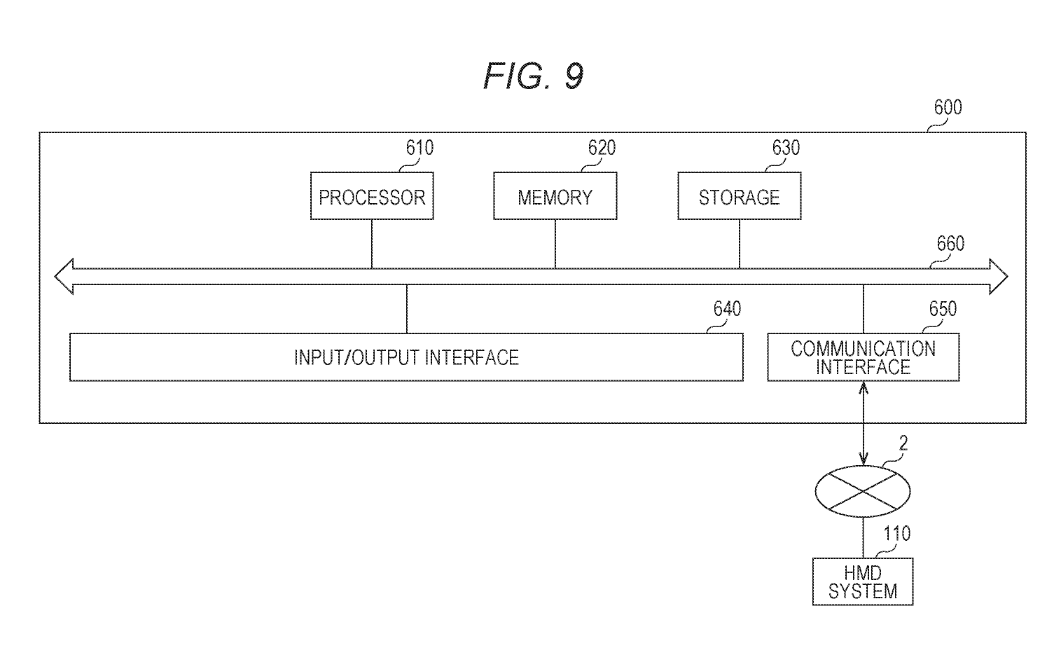

With reference to FIG. 9, the server 10 in this embodiment is described. FIG. 9 is a block diagram for illustrating an example of a hardware configuration of the server 600 in one embodiment of this disclosure. The server 600 includes, as primary components, a processor 610, a memory 620, a storage 630, an input/output interface 640, and a communication interface 650. Each component is connected to a bus 660.

The processor 610 executes a series of commands included in a program stored in the memory 620 or the storage 630 based on a signal transmitted to the server 600 or on satisfaction of a condition determined in advance. In one aspect, the processor 10 is implemented as a central processing unit (CPU), a graphics processing unit (GPU), a microprocessing unit (MPU), afield-programmable gate array (FPGA), or other devices.

The memory 620 temporarily stores programs and data. The programs are loaded from, for example, the storage 630. The data includes data input to the server 600 and data generated by the processor 610. In one aspect, the memory 620 is implemented as a random access memory (RAM) or other volatile memories.

The storage 630 permanently stores programs and data. The storage 630 is implemented as, for example, a read-only memory (ROM), a hard disk device, a flash memory, or other non-volatile storage devices. The programs stored in the storage 630 include programs for providing a virtual space in the HMD system 100, simulation programs, game programs, user authentication programs, and programs for implementing communication to/from other computers 200. The data stored in the storage 630 may include, for example, data and objects for defining the virtual space.

In another aspect, the storage 630 may be implemented as a removable storage device like a memory card. In another aspect, a configuration that uses programs and data stored in an external storage device may be used instead of the storage 630 built into the server 600. With such a configuration, for example, in a situation in which a plurality of HMD systems 100 are used as in an amusement facility, the programs and the data can be collectively updated.

The input/output interface 640 allows communication of signals to/from an input/output device. In one aspect, the input/output interface 640 is implemented with use of a USB, a DVI, an HDMI, or other terminals. The input/output interface 640 is not limited to ones described above.

The communication interface 650 is connected to the network 2 to communicate to/from the computer 200 connected to the network 2. In one aspect, the communication interface 650 is implemented as, for example, a LAN, other wired communication interfaces, Wi-Fi, Bluetooth, NFC, or other wireless communication interfaces. The communication interface 650 is not limited to ones described above.

In one aspect, the processor 610 accesses the storage 630 and loads one or more programs stored in the storage 630 to the memory 620 to execute a series of commands included in the program. The one or more programs may include, for example, an operating system of the server 610, an application program for providing a virtual space, and game software that can be executed in the virtual space. The processor 610 may transmit a signal for providing a virtual space to the HMD device 110 to the computer 200 via the input/output interface 640.

[Control Device of HMD]

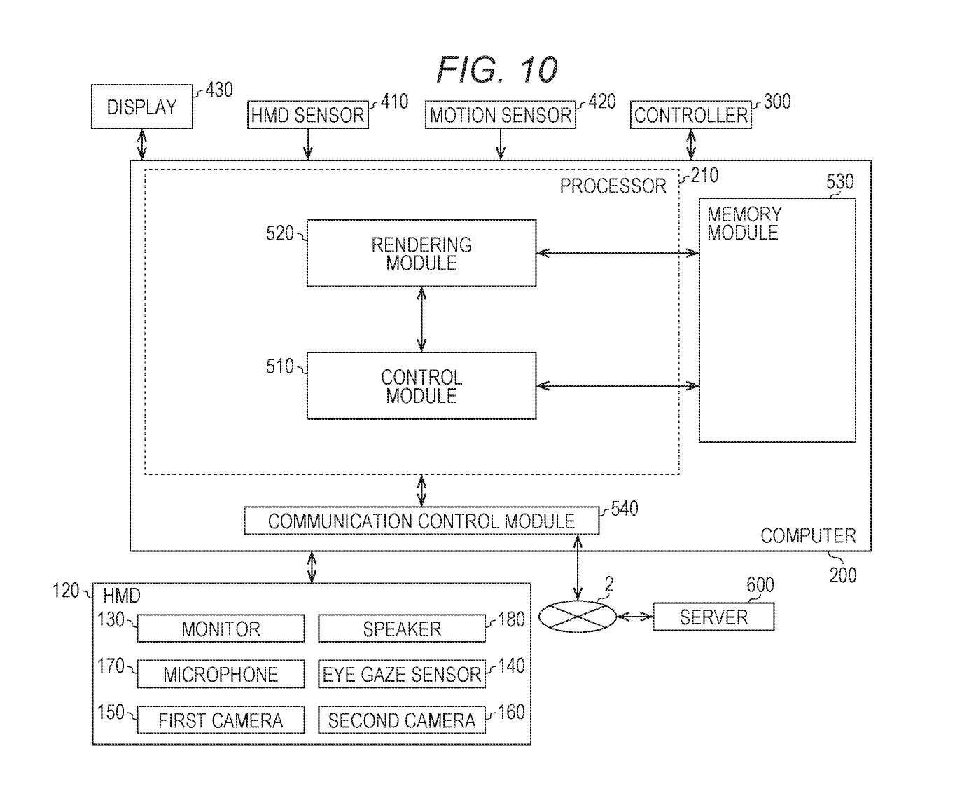

With reference to FIG. 10, the control device of the HMD 21 is described. According to one embodiment of this disclosure, the control device is implemented by the computer 200 having a known configuration. FIG. 10 is a block diagram for illustrating the computer 200 in one embodiment of this disclosure in terms of its module configuration.

As illustrated in FIG. 10, the computer 200 includes a control module 510, a rendering module 520, a memory module 530, and a communication control module 540. In one aspect, the control module 510 and the rendering module 520 are implemented by the processor 210. In another aspect, a plurality of processors 210 may actuate as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. The control module 510 may generate virtual space data by itself or acquire virtual space data from, for example, the server 600.

The control module 510 arranges objects in the virtual space 11 using object data representing objects. The object data is stored in, for example, the memory module 530. The control module 510 may generate virtual space data by itself or acquire object data from, for example, the server 600. The objects may include, for example, an avatar object of the user 5, character objects, operation objects, for example, a virtual hand to be operated by the controller 300, and forests, mountains, other landscapes, streetscapes, and animals to be arranged in accordance with the progression of the story of the game.

The control module 510 arranges an avatar object of the user 5 of another computer 200, which is connected via the network 2, in the virtual space 11. In one aspect, the control module 510 arranges an avatar object of the user 5 in the virtual space 11. In one aspect, the control module 510 arranges an avatar object simulating the user 5 in the virtual space 11 based on an image including the user 5. In another aspect, the control module 510 arranges an avatar object in the virtual space 2, which is selected by the user 5 from among a plurality of types of avatar objects (e.g., objects simulating animals or objects of deformed humans).

The control module 510 identifies an inclination of the HMD 120 based on output of the HMD sensor 410. In another aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In another aspect, the control module 510 may be configured to transmit line-of-sight information representing the line of sight of the user 5 to the server 600. In such a case, the control module 510 may calculate the point-of-view position based on the line-of-sight information received by the server 600.

The control module 510 reflects a motion of the HMD 120, which is detected by the HMD sensor 410, in an avatar object. For example, the control module 510 detects inclination of the HMD 120, and arranges the avatar object in an inclined manner. The control module 510 reflects the detected motion of face parts in a face of the avatar object arranged in the virtual space 11. The control module 510 receives line-of-sight information of another user 5 from the server 600, and reflects the line-of-sight information in the line of sight of the avatar object of another user 5. In one aspect, the control module 510 reflects a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In one aspect, the operation object may include, for example, a hand object serving as a virtual hand corresponding to a hand of the user 5. In one aspect, the control module 510 moves the hand object in the virtual space 11 so that the hand object moves in association with a motion of the hand of the user 5 in the real space based on output of the motion sensor 420. In one aspect, the operation object may correspond to a hand part of an avatar object.

When one object arranged in the virtual space 11 collides with another object, the control module 510 detects the collision. The control module 510 can detect, for example, a timing at which a collision area of one object and a collision area of another object have touched with each other, and performs predetermined processing when the timing is detected. The control module 510 can detect a timing at which an object and another object, which have been in contact with each other, have become away from each other, and performs predetermined processing when the timing is detected. The control module 510 can detect a state in which an object and another object are in contact with each other. For example, when an operation object touches with another object, the control module 510 detects the fact that the operation object has touched with another object, and performs predetermined processing.

In one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 510 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs voices (utterances) corresponding to the voice data from the speaker 180.

The memory module 530 holds data to be used to provide the virtual space 11 to the user 5 by the computer 200. In one aspect, the memory module 530 holds space information, object information, and user information.

The space information holds one or more templates defined to provide the virtual space 11.

The object information stores a plurality of panorama images 13 forming the virtual space 11 and object data for arranging objects in the virtual space 11. The panorama image 13 may contain a still image and a moving image. The panorama image 13 may contain an image in a non-real space and an image in the real space. An example of the image in a non-real space is an image generated by computer graphics.

The user information stores a user ID for identifying the user 5. The user ID may be, for example, an internet protocol (IP) address or a media access control (MAC) address set to the computer 200 used by the user. In another aspect, the user ID may be set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

The communication control module 540 may communicate to/from the server 600 or other information communication devices via the network 2.

In one aspect, the control module 510 and the rendering module 520 may be implemented with use of, for example, Unity (trademark) provided by Unity Technologies. In another aspect, the control module 510 and the rendering module 520 may also be implemented by combining the circuit elements for implementing each step of processing.

The processing performed in the computer 200 is implemented by hardware and software executed by the processor 410. The software may be stored in advance on a hard disk or other memory module 530. The software may also be stored on a CD-ROM or other computer-readable non-volatile data recording media, and distributed as a program product. The software may also be provided as a program product that can be downloaded by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

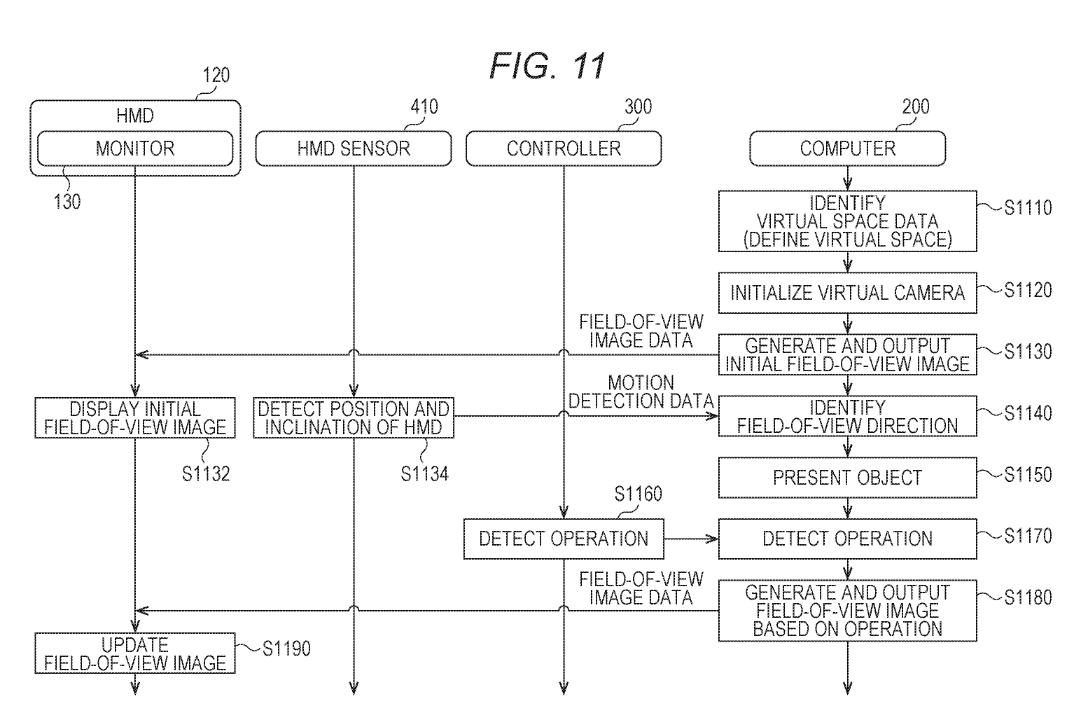

With reference to FIG. 11, the control structure of the HMD set 110 is described. FIG. 11 is a sequence chart for illustrating a part of processing to be executed by the HMD system 100 in one embodiment of this disclosure.

As illustrated in FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 may recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In another aspect, an operation of the controller 300 by the user 5 may be detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

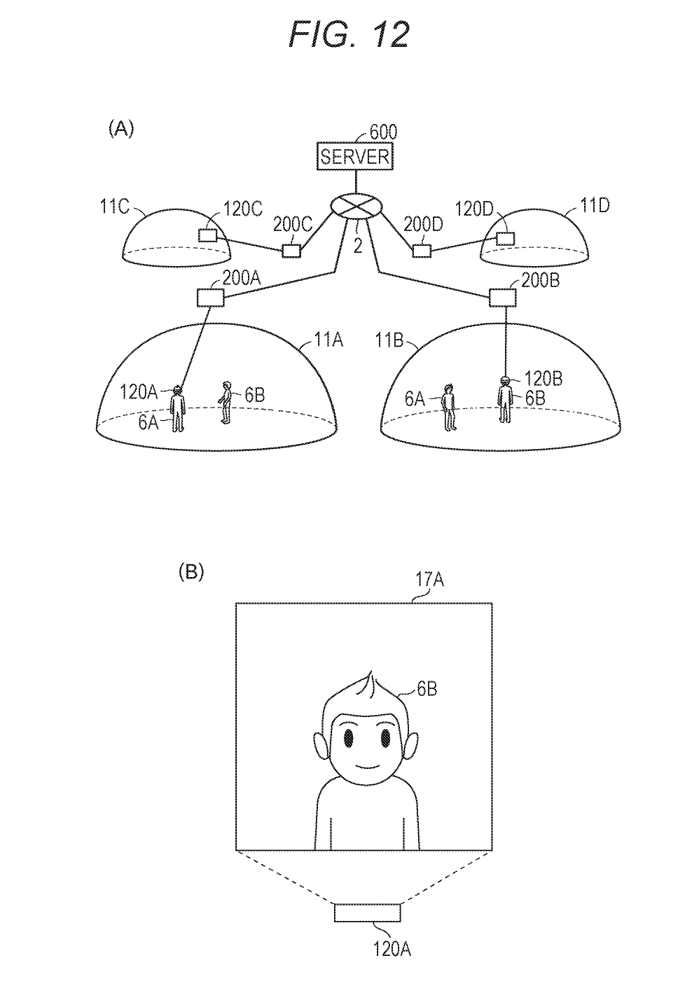

With reference to FIG. 12 (A) and FIG. 12 (B), an avatar object in this embodiment is described. FIG. 12(A) and FIG. 12(B) are diagrams for illustrating avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12(A) is a schematic diagram for illustrating a situation in which each HMD 120 provides the user 5 with the virtual space 11. Computers 200A to 200D provide the users 5A to 5D with virtual spaces 11A to 11D via HMDs 120A to 120D, respectively. In the example illustrated in FIG. 12(A), the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, this illustration is only for the sake of simplicity of description, and those objects do not wear the HMD 120 in actuality.

In one aspect, the processor 210A may arrange a virtual camera 14A for photographing a field-of-view region 17A of the user 5A at the position of eyes of the avatar object 6A.

FIG. 12(B) is a diagram for illustrating the field-of-view region 17A of the user 5A in FIG. 12(A). The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not particularly illustrated in FIG. 12B, the avatar object 6A of the user 5A is displayed in the field-of-view image of the user 5B.

Under the state of FIG. 12(B), the user 5A can communicate to/from the user 5B via the virtual space 11A through conversation. More specifically, voices of the user 5A acquired by a microphone 170A are transmitted to the HMD17120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A reflects an operation by the user 5B (operation of HMD 120B and operation of controller 300B) in the avatar object 6B arranged in the virtual space 11A. With this, the user 5A can recognize the operation by the user 5B through the avatar object 6B.

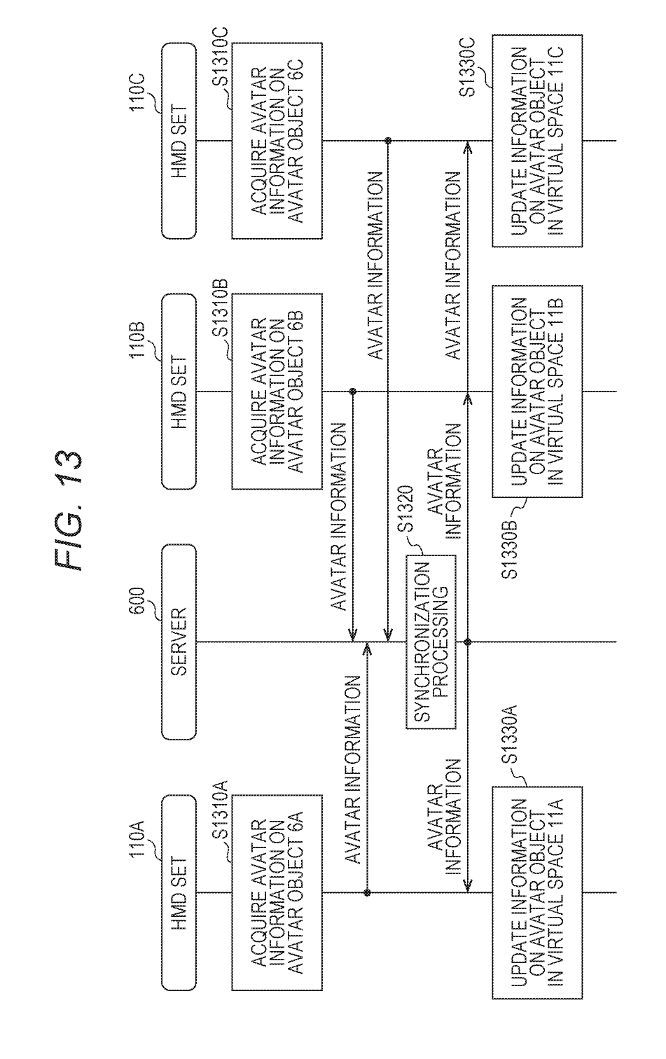

FIG. 13 is a sequence chart for illustrating a part of processing to be executed by the HMD system 100 in this embodiment. In FIG. 13, although the HMD set 110D is not illustrated, the HMD set 110D operates in the same manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. The avatar information may contain information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210B of the HMD set 110B acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD11020C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 540. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Details of Module Configuration]

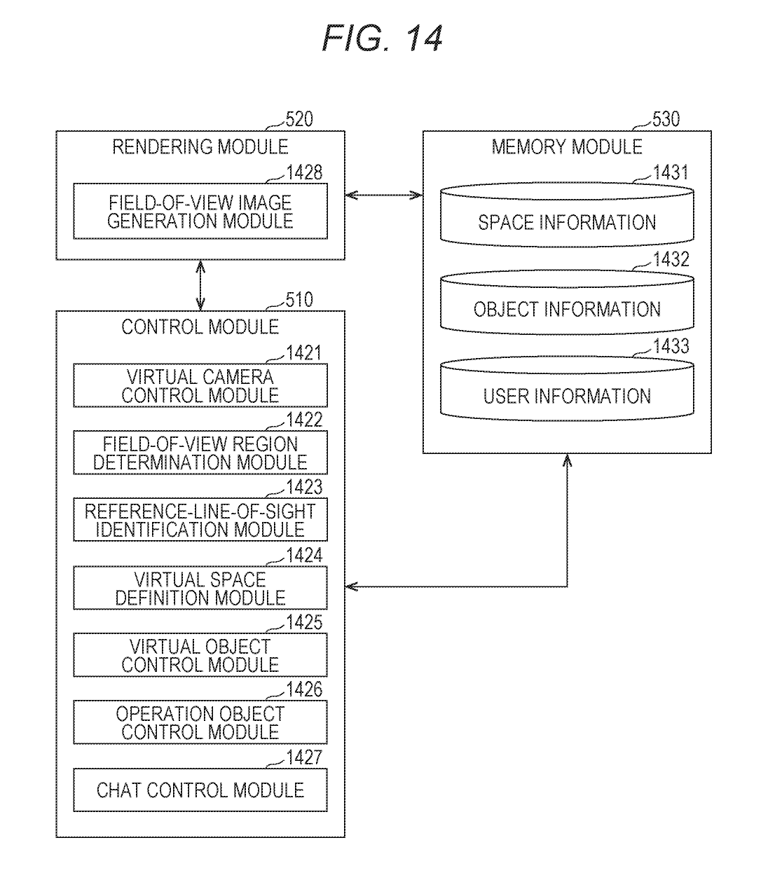

With reference to FIG. 14, details of a module configuration of the computer 200 are described. FIG. 14 is a block diagram for illustrating details of the module configuration of the computer 200 in one embodiment of this disclosure.

As illustrated in FIG. 14, the control module 510 includes a virtual camera control module 1421, a field-of-view region determination module 1422, a reference-line-of-sight identification module 1423, a virtual space definition module 1424, a virtual object control module 1425, an operation object control module 1426, and a chat control module 1427. The rendering module 520 includes a field-of-view image generation module 1428. The memory module 530 stores space information 1431, object information 1432, and user information 1433.

The virtual camera control module 1421 arranges the virtual camera 14 in the virtual space 11, and controls, for example, a behavior and direction of the virtual camera 14. The field-of-view region determination module 1422 determines the field-of-view region 15 based on the direction of the head of the user wearing the HMD 120. The field-of-view image generation module 1428 generates the field-of-view image to be displayed on the monitor 130 based on the determined field-of-view region 15. The field-of-view image generation module 1428 determines modes of display of avatar objects contained in the field-of-view image. Whether or not avatar objects are contained in the field-of-view image is determined depending on, for example, whether or not the field-of-view region 15 determined based on the field-of-view direction of the user contains avatar objects. The reference-line-of-sight identification module 1423 identifies the line of sight of the user 5 based on a signal from the eye gaze sensor 140.

The control module 510 controls the virtual space 11 to be provided to the user 5. The virtual space defining module 1424 generates virtual space data representing the virtual space 11 to define the virtual space 11 in the HMD system 100.

The virtual object control module 1425 generates a target object to be arranged in the virtual space 11. The virtual object control module 1425 controls actions (motion, change in state, and the like) of the target object and the avatar object in the virtual space 11. Examples of the target object may include forests, mountains, other landscapes, and animals to be arranged in accordance with the progress of the story of the game. The avatar object represents an object (so-called avatar) associated with the user wearing the HMD 120 in the virtual space 11.

The operation object control module 1426 arranges in the virtual space 11 an operation object for operating an object arranged in the virtual space 11. In one aspect, examples of the operation object may include a hand object corresponding to a hand of the user wearing the HMD 120, a finger object corresponding to a finger of the user, and a stick object corresponding to a stick to be used by the user. When the operation object is a finger object, in particular, the operation object corresponds to a portion of an axis in the direction (axial direction) indicated by that finger.

The controller 300 detects an operation performed by the user 5 in the real space. For example, in one aspect, the controller 160 detects the fact that the button has been pressed by the user 5. In another aspect, the controller 160 detects the motion of both hands of the user 190 (e.g., waving both hands). The signal representing the details of detection is transmitted to the computer 200.

The operation object control module 1426 reflects the detection details transmitted from the controller 160 in the virtual space 11. Specifically, the processor 210 moves an operation object (e.g., hand object representing hand of avatar object) in the virtual space 11 based on a signal representing the detection details. The processor 210 serves as the operation object control module 1426 to detect an operation (e.g., grasping operation) determined in advance and performed on the target object by the operation object.

The chat control module 1427 performs control for enabling a chat with an avatar object of another user staying in the same virtual space 11. For example, the chat control module 1427 transmits to the server 600 information on, for example, the position and direction of an avatar object of the user and voice information input to the microphone 170. The chat control module 1427 outputs the voice data on another user received from the server 600 to a speaker (not shown). In this manner, a voice chat is implemented. The chat is not limited to the one that is based on voice data, but may be the one that is based on text data. In this case, the chat control module 1427 controls transmission and reception of text data.

When one object arranged in the virtual space 11 collides with another object, the control module 510 detects the collision. The control module 510 can detect, for example, a timing at which an object and another object have touched with each other, and performs predetermined processing when the timing is detected. The control module 510 can detect a timing at which an object and another object, which have been in contact with each other, have become away from each other, and performs predetermined processing when the timing is detected. The control module 510 can detect a state in which an object and another object are in contact with each other. Specifically, when an operation object touches with another object (for example, the target object arranged by the virtual object generation module 1425), the operation object control module 1426 detects the fact that the operation object has touched with another object, and performs predetermined processing.

The space information 1431 includes, for example, one or more templates that are defined to provide the virtual space 11. The object information 1432 includes, for example, content to be reproduced in the virtual space 11, and information for arranging objects to be used in the content. The content may include, for example, game content and content representing landscapes that resemble those of the real society. The user information 1433 includes, for example, a program for causing the computer 200 to function as a control device of the HMD system 100 and an application program that uses each content stored in the object information 1432.

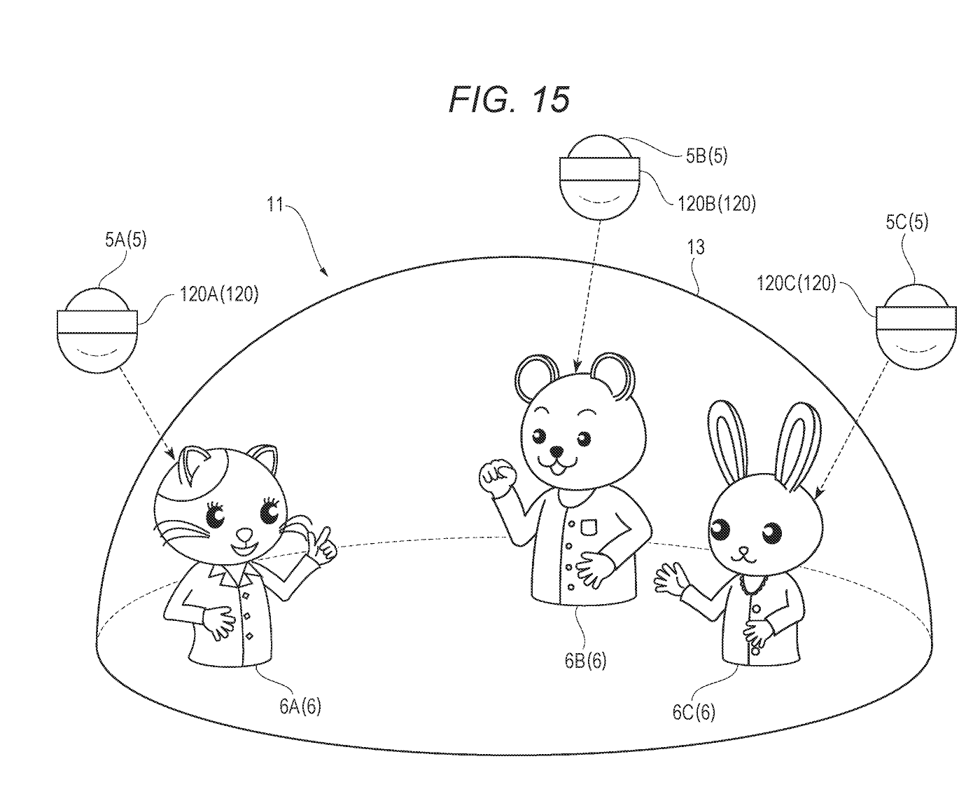

FIG. 15 a diagram for schematically illustrating the virtual space 11 shared by a plurality of users. In the example illustrated in FIG. 15, an avatar object 6A (first avatar object) associated with the user 5A wearing the HMD 120A, an avatar object 6B (second avatar object) associated with the user 5B wearing the HMD 120B, an avatar object 6C (second avatar object) associated with the user 5C wearing the HMD 120C are arranged in the same virtual space 11. With the virtual space 11 shared by the plurality of users, it is possible to provide each user with a communication experience, for example, a chat (VR chat), with other users via the avatar objects 6.

In this example, each avatar object 6 is defined as an object simulating an animal (cat, rabbit, or bear). The avatar object 6 is formed of a head part that moves in synchronization with motion of the HMD 120 detected by, for example, the HMD sensor 140, a hand part that moves in synchronization with motion of a hand of the user detected by, for example, the motion sensor 420, a body part and arm part that are displayed in connection with the head part and hand part. Control of motion is complicated for a leg part that is below a hip, and thus the avatar object 6 does not include a leg part.

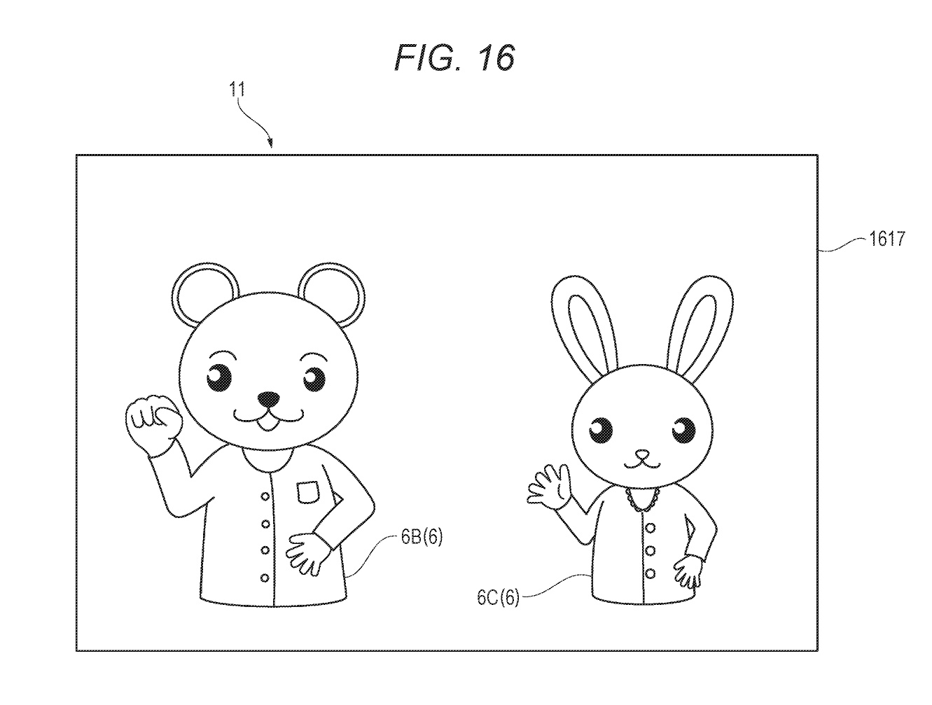

The field of view of the avatar object 6A is the same as the field of view of the virtual camera 14 in the HMD system 100A. Thus, the user 5A is provided with a field-of-view image 1617 from the first-person point of view of the avatar object 6A. That is, the user 5A is provided with a virtual experience as if the user 5A himself or herself were in the virtual space 11 as the avatar object 6A. FIG. 16 is a diagram for illustrating the field-of-view image 1617 provided to the user 5A via the HMD device 120A. The users 5B and 5C are also provided with the field-of-view images from the first-person points of view of the avatar objects 6B and 6C as well, respectively.

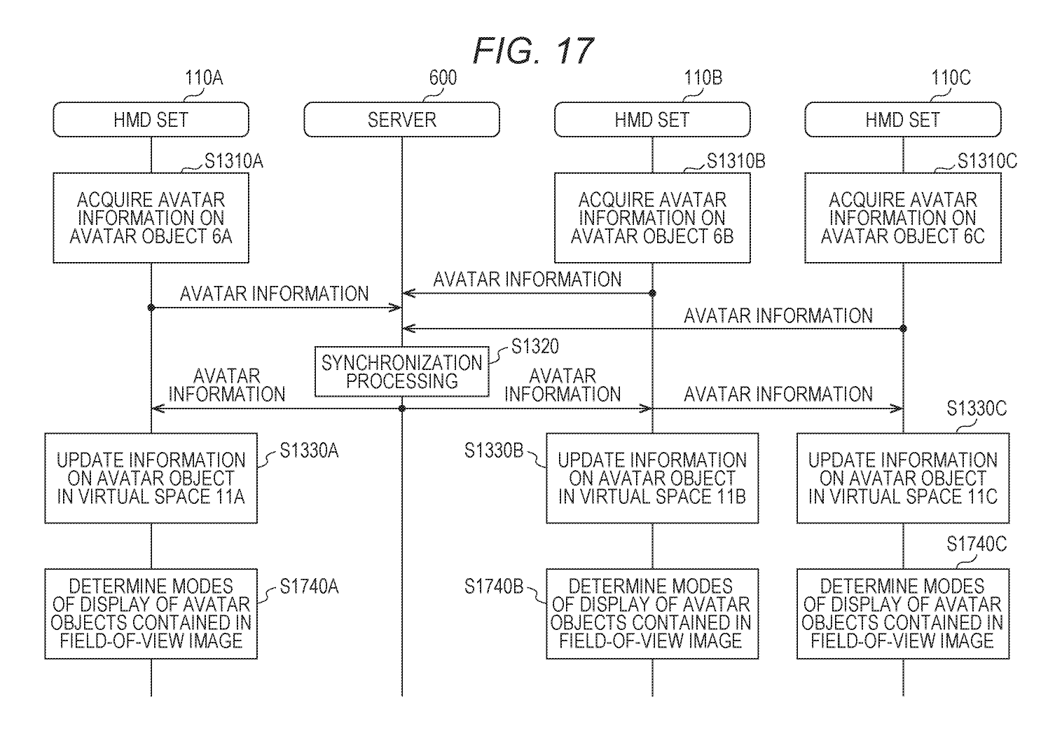

FIG. 17 is a sequence diagram for illustrating processing to be executed by the HMD set 110A, the HMD set 110B, the HMD set 110C, and the server 600 in order to implement the VR chat described above. The processing of from Steps S1310A, S1310B, and S1310C to Steps S1330A, S1330B, and S1330C is similar to that of FIG. 13.

In the example illustrated in FIG. 17, avatar information contains emotion data. The emotion data is information representing the emotion of the user 5, and for example, is information containing an emotion type (e.g., happiness, anger, or sadness) and an emotion degree (e.g., represented by 10 levels). For example, the processor 210 generates emotion data by certain emotion recognition processing using the face tracking data or voice data. Images generated by the first camera 150 and the second camera 160 may be used to detect a facial expression of the user and generate face tracking data through image analysis processing by detecting, for example, motion of pupils, opening/closing of eyelids, and motion of eyebrows of the user 5, or for example, motion of a mouth, cheek, and chin of the user 5.

Next, the HMD sets 110A to 110C execute processing of Step S1740A to Step S1740C, respectively. The processing of Step S1740A corresponds to a part of the processing of Step S1180 illustrated in FIG. 11.

In Step S1740A, the processor 210 in the HMD set 110A serves as the field-of-view image generation module 1428 to determine modes of display of the avatar objects 6 contained in the field-of-view image 1617. Specifically, the processor 210 extracts avatar objects 6 contained in the field-of-view image 15, which is determined based on the field-of-view direction of the virtual camera 14 (avatar object 6A). In the examples illustrated in FIG. 15 and FIG. 16, the field-of-view region of the virtual camera 14 in the HMD set 110A contains the avatar objects 6B and 6C. Thus, the processor 210 extracts the avatar objects 6B and 6C as the avatar objects 6 contained in the field-of-view image 1617, and determines the modes of display of the avatar objects 6B and 6C.

Processing of Step S1740B and Step S1740C in the HMD sets 110B and 110C is similar to the processing of Step S1740A in the HMD set 110A. Processing of determining the mode of display of the avatar object 6C in Step S1740A is similar to processing of determining the mode of display of the avatar object 6B. Thus, in the following, a description is given in detail of only the processing of determining the mode of display of the avatar object 6B in Step S1740A.

For example, the processor 210 in the HMD system 110A may generate motion data defining motion of each face part of the avatar object 6B based on the face tracking data on the user 5B received as the avatar information. With this motion data, it is possible to change the facial expression of the avatar object 6B contained in the field-of-view image 1617. For example, the processor 210 may generate an image representing the position and shape of each part of the face of the avatar object 6B based on the position and shape of each part of the face of the user 5B represented by the face tracking data. Then, the processor 210 may determine the image as the face image of the avatar object 6B. With this, the change in facial expression of the user 5B participating in a VR chat can be reflected as the facial expression of the avatar object 6B in the virtual space 11. As a result, emotional understanding among the users in the virtual space 11 may be facilitated.

The memory module 530 of the HMD set 110A may hold in advance a plurality of facial expression images (e.g., image corresponding to surprise and image corresponding to sadness) corresponding to a plurality of facial expressions of the avatar object 6B as the object information 1432. In this case, the processor 210 may determine, as the face image of the avatar object 6B, a facial expression image corresponding to the emotion type and emotion degree represented by the emotion data on the user 5B received as the player information. With this, the face tracking data is not required to be used to represent the facial expression of the avatar object 6B in the field-of-view image 1617, and thus the data communication amount may be reduced by eliminating communication of the face tracking data. The processing required for representing the facial expression of the avatar object 6B is reduced to processing of simply extracting an image corresponding to the emotion data from among the plurality of facial expression images prepared in advance. Therefore, it is possible to reduce the processing amount and speed up the processing.

When the facial expression of the avatar object 6B is switched from one facial expression to another among the plurality of facial expression images prepared in advance as described above, the processor 210 may execute so-called morphing processing. Morphing is processing of interpolating a video image in an intermediate state of two different states (in this case, two different states of facial expression) by a computer. For example, the processor 210 may prepare a facial expression image (first facial expression image, for example, facial expression image representing surprise) of the avatar object 6B corresponding to emotion data on the user 5B received in the previous synchronization processing and a facial expression image (second facial expression image, for example, facial expression image representing happiness) of the avatar object 6B corresponding to emotion data on the user 5B received in the current synchronization processing, and execute morphing to generate a video image (motion data) in an intermediate state of those two facial expression images. With the video image in an intermediate state generated in this manner, it is possible to represent a natural change in facial expression of the avatar object 6B on the field-of-view image 1617 provided to the user 5A. Specifically, the processor 210 may output, as part of the field-of-view image data, the video image in an intermediate state generated in this manner to the HMD 120A as well as the facial expression image of the avatar object 6B corresponding to the emotion data on the user 5B received in the current synchronization processing. With this, it is possible to represent a natural change in facial expression of the avatar object 6B on the field-of-view image M provided to the user 5A. As a result, the user 5A can be provided with a higher sense of immersion in the virtual space 11.

The processor 210 in the HMD set 110A may serve as the chat control module 1427 to output voice data contained in the avatar information to, for example, a speaker, in parallel to the processing in Step S1740A. Specifically, the processor 210 may output the voice data in synchronization with motion of the avatar object 6B. In this case, the user 5A can grasp details of utterance by the user 5B as details of utterance by the avatar object 6B. With this, the user 5A can be provided with a higher sense of immersion in the virtual space 11.

With the processing of Step S1740A as described above, it is possible to provide the user 5A with the field-of-view image 1617 that has reflected, for example, the motions and facial expressions of the other users 5B and 5C in the avatar objects 6B and 6C. Similarly, through the processing of Step S1740B and Step S1740C, it is possible to provide the users 5B and 5C with similar field-of-view images.

[Effect Display]

In this embodiment, in order to facilitate emotional understanding among the users in a VR chat, the processor 210 in the HMD set 110A executes the following processing as a part of processing (processing corresponding to Step S1180 in FIG. 11 and Step S1740A in FIG. 17) of determining modes of display of the avatar objects 6 contained in the field-of-view image 1617. Specifically, the processor 210 executes processing (effect control) of arranging (superimposing for display) effect images that are synchronized with emotions of the other users 5B and 5C (second users) on the avatar objects 6B and 6C (second avatar objects) of those other users, respectively, in the field-of-view image 1617 provided to the user 5A (first user). In the following, a description is given of first and second examples of effect control.

### First Example

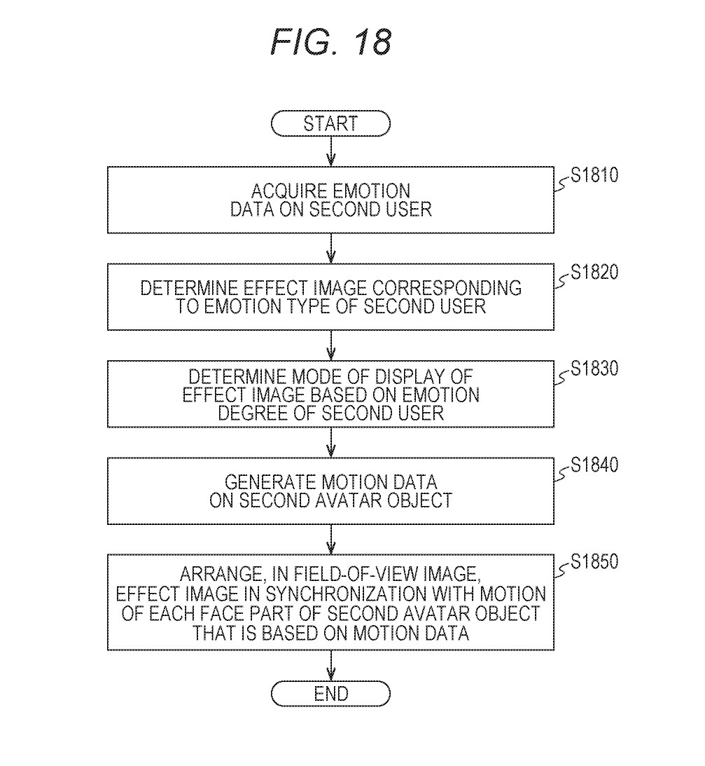

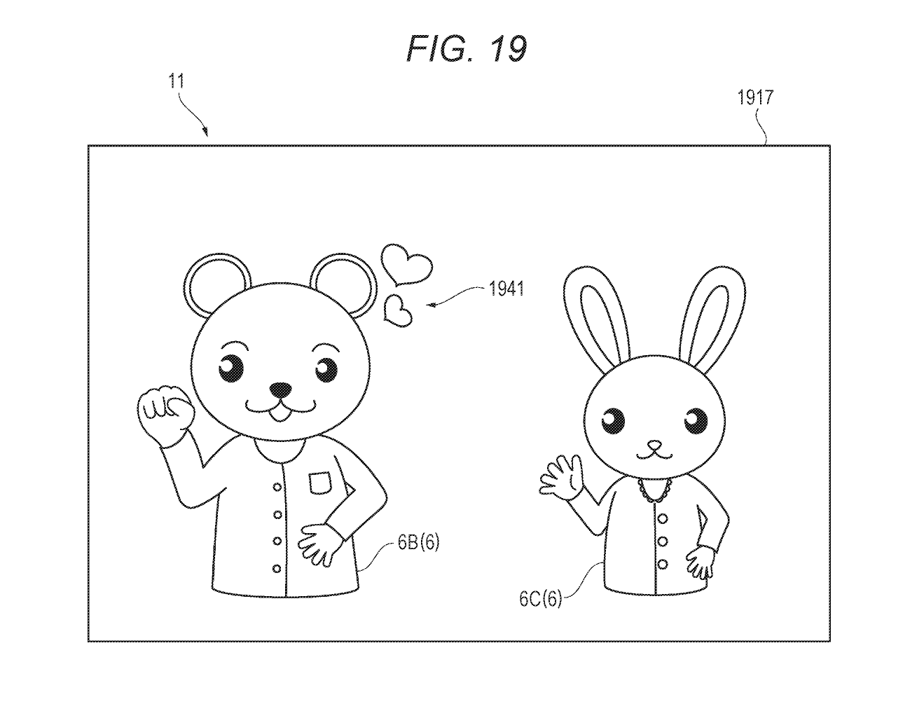

Now, a description is given of the first example of effect control with reference to FIG. 18 and FIG. 19. FIG. 18 is a flowchart for illustrating processing to be executed by the HMD set 110A in the first example of effect control.

In Step S1810, the processor 210 acquires emotion data on the second user associated with the avatar object 6 contained in the field-of-view image 1617. For example, the processor 210 can acquire the emotion data from player information on the second user received from the server 600. With this, the processor 210 identifies the emotion of the second user.

In Step S1820, the processor 210 determines an effect image corresponding to the emotion type of the second user. The effect image for each emotion type is stored in the memory module 530 in advance as the object information 1432. An example of the effect image is, for example, a heart shape image corresponding to an emotion “happiness”. The processor 210 extracts an effect image corresponding to the emotion type of the second user contained in emotion data from among effect images prepared in advance for respective types of emotions.

In Step S1830, the processor 210 determines the mode of display of an effect image based on the emotion degree of the second user. Specifically, the processor 210 determines the degree of representation of the effect image in the field-of-view image 1617 based on the emotion degree of the second user contained in emotion data. For example, the processor 210 may determine, for example, the number and size of effect images (e.g., “heart shape”) based on the degree of emotion (e.g., “happiness”) of the second user. For example, the processor 210 may determine the mode of display of an effect image so that, as the emotion degree of the second user becomes larger, the number of effect images becomes larger (or size of effect image becomes larger). With this, the first user can visually grasp the emotion degree of the second user by the degree of representation of the effect image.

In Step S1840, as described above, the processor 210 generates motion data on the second avatar object representing motion (change in facial expression) of each face part of the second avatar object based on the face tracking data (image recognition result of face image) or emotion data on the second user. Step S1840 may be executed before Step S1810 to Step S1830, or in parallel to Step S1810 to Step S1830.

In Step S1850, the processor 210 arranges, in the field-of-view image 1617, an effect image in synchronization with motion of each face part of the second avatar object that is based on the motion data. For example, the processor 210 superimposes the effect image for display at a position in the field-of-view image 1617, which is determined in advance with the position of the second avatar object serving as a reference. The processor 210 associates motion data with an effect image so that a timing at which motion of each face part that is based on the motion data is displayed (reproduced) on the monitor 130 of the HMD 120A and a timing at which the effect image is displayed on the monitor 130 of the HMD 120A match each other. Then, the processor 210 outputs those pieces of data associated with each other in this manner to the HMD 120A. With this, a field-of-view image in which the effect image is displayed in synchronization with motion of each face part of the second avatar object is provided to the first user wearing the HMD 120A. As a result, the first user can effectively grasp the emotion of the second user by both of change in facial expression of the second avatar object and the effect image. As an example, the processor 210 may generate such a field-of-view image that an effect image of a heart shape comes out of eyes of the second avatar object in synchronization with blinking motion of the second avatar object.

FIG. 19 is a diagram for illustrating an example of the field-of-view image (field-of-view image 1917) to be generated by the first example of effect control. The example illustrated in FIG. 19 is an example of a case in which the emotion type of the user 5B associated with the avatar object 6B is determined as “happiness” and the emotion degree is determined as “medium”. In the example illustrated in FIG. 19, in Step S1820 described above, the processor 210 determines a heart shape image corresponding to the emotion type “happiness” of the user 5B as an effect image 1941 associated with the avatar object 6B. In Step S1830 described above, the processor 210 determines a mode of display of displaying two heart shapes as the mode of display corresponding to the emotion degree “medium” of the user 5B. As illustrated in the field-of-view image 1917, an effect image is not displayed for the avatar object 6C of the user 5C for which an emotion having a corresponding effect image has not been identified.

In this manner, it is possible to allow the user 5A to easily grasp an emotion of the second user (user 5B in example illustrated in FIG. 19) by arranging the effect image 1941 in the field-of-view image 1917. As a result, emotional understanding among the users in the virtual space 11 may be facilitated.

### Second Example

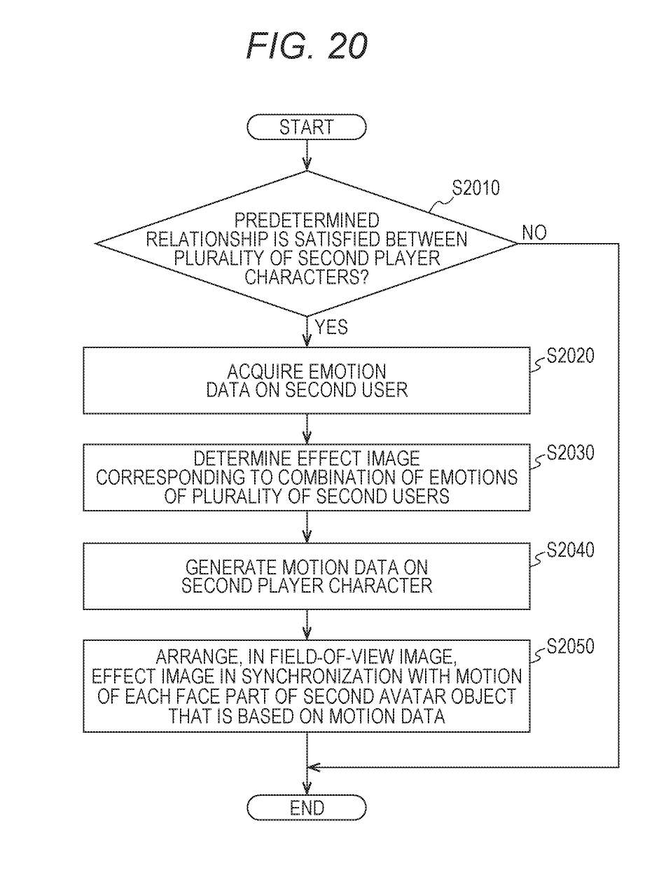

With reference to FIG. 20 to FIG. 22, a description is given of a second example of the effect control. In the second example, when a predetermined relationship is satisfied between the avatar objects 6B and 6C (second avatar objects) associated with the users 5B and 5C (second users), the processor 210 determines and arranges an effect image based on a combination of the emotion of the user 5B and the emotion of the user 5C. Specifically, the processor 210 serves as the field-of-view image generation module 1428 to execute the following processing in the processing of determining the mode of display described above (processing corresponding to Step S1180 in FIG. 11 and Step S1740A in FIG. 17). FIG. 20 is a flowchart for illustrating processing to be executed by the HMD set 110A in the second example of effect control.

In Step S2010, the processor 210 determines whether or not a predetermined relationship is satisfied between a plurality of (two in this case) second avatar objects. The predetermined relationship in this case is a relationship that is recognized by all of the plurality of second avatar objects. As an example, the predetermined relationship is a relationship of the plurality of second avatar objects facing each other (relationship of looking at each other). For example, the processor 210 can determine whether or not the plurality of second avatar objects are facing each other based on information on, for example, the positions and directions of those plurality of second avatar objects. Such information is received as player information described above. When it is determined that the plurality of second avatar objects are facing each other, the processor 210 proceeds to execute processing of from Step S2020 to Step S2050.

In Step S2020, the processor 210 executes processing similar to that of Step S1810 to acquire emotion data on the second user associated with the avatar object 6 contained in the field-of-view image 1617.

In Step S2030, the processor 210 determines an effect image corresponding to a combination of emotions of the plurality (two in this case) of second users. The effect image for each combination of emotions is stored in advance in the memory module 530 as, for example, the object information 1432.

For example, an example of the effect image corresponding to a combination of the emotion “happiness” and the emotion “happiness” is an image (e.g., image representing heart shape) representing the fact that the plurality of second users love each other (mutual love). An example of the effect image corresponding to a combination of the emotion “anger” and the emotion “anger” is an image (e.g., image representing spark) representing the fact that the plurality of second users are hostile to each other. For example, an example of the effect image corresponding to a combination of the emotion “happiness” and the emotion “unhappiness” is an image (e.g., image representing broken heart shape) representing the fact that one of the plurality of second users loves the other one-sidedly.

The processor 210 extracts an effect image corresponding to a combination of emotions of the plurality of second users from among effect images prepared in advance for respective combinations of emotions.

In Step S2040 and Step S2050, the processor 210 executes processing similar to those of Step S1840 and Step S1850 described above.

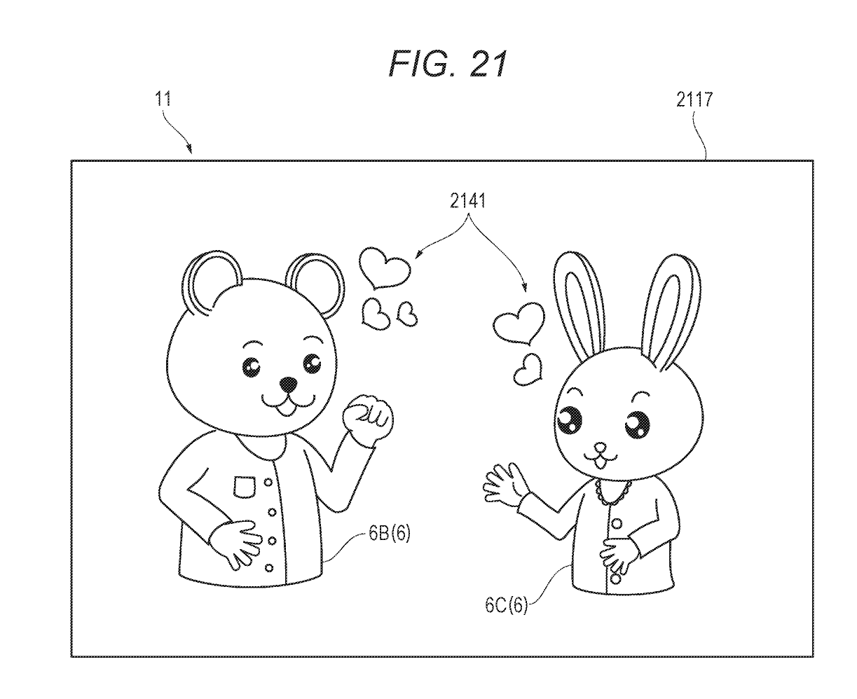

FIG. 21 is a diagram for illustrating an example of the field-of-view image (field-of-view image 2117) to be generated by the second example of effect control. The field-of-view image 2117 illustrated in FIG. 21 is a field-of-view image generated in the following manner. That is, in Step S2010, the processor 210 determines whether or not a predetermined relationship (relationship of facing each other) is satisfied between the avatar object 6B and the avatar object 6C. Thus, the processor 210 executes the processing of from Step S2020 to Step S2050. In Step S2020, the processor 210 acquires emotion data on the user 5B associated with the avatar object 6B and emotion data on the user 5C associated with the avatar object 6C. In this case, the emotion type contained in the emotion data on the user 5B and the emotion type contained in the emotion data on the user 5C are both “happiness”. Thus, in Step S2030, the processor 210 determines an effect image 2141 (image representing heart shape in this example) corresponding to a combination of the emotion “happiness” and the emotion “happiness” based on the combination thereof. Then, the processor 210 executes the processing of Step S2040 and Step S2050 to generate the field-of-view image 2117 in which the effect image 2141 is arranged in association with the avatar objects 6B and 6C.

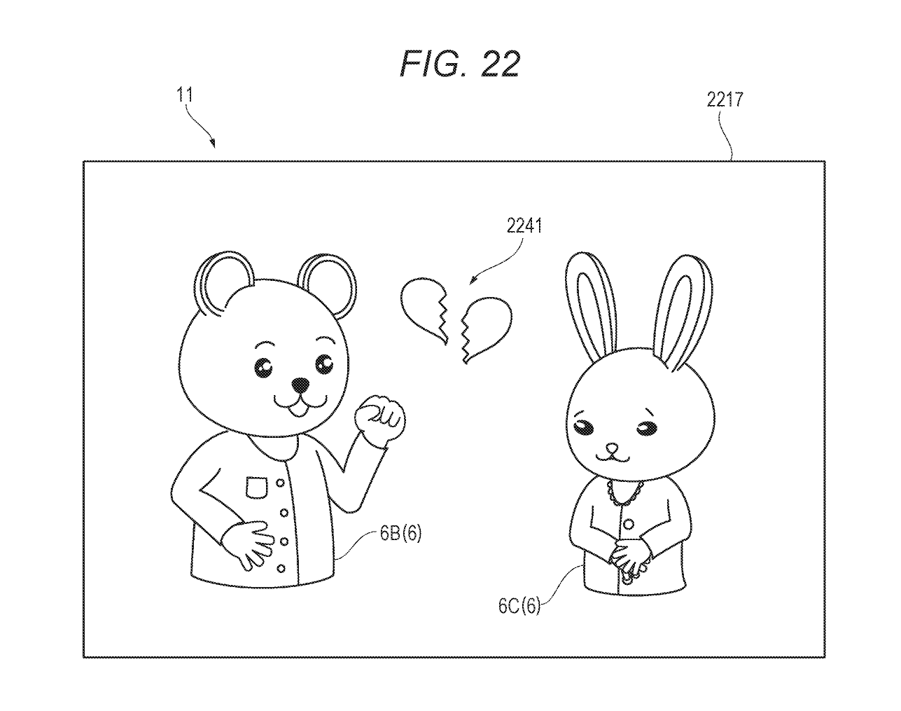

FIG. 22 is a diagram for illustrating another example of the field-of-view image (field-of-view image 2217) to be generated by the second example of effect control. The example illustrated in FIG. 22 is different from the example illustrated in FIG. 21 in that the emotion type of the user 5C associated with the avatar object 6C is “unhappiness”. Thus, in the field-of-view image 2217 illustrated in FIG. 22, an effect image 2241 (e.g., image representing broken heart shape in this case) corresponding to a combination of the emotion “happiness” and the emotion “unhappiness” is determined based on the combination thereof.

According to the second example, it is possible to display an effect image E, which is synchronized with the emotions of the plurality of second users (users 5B and 5C in examples illustrated in FIG. 21 and FIG. 22) directed to each other. With this, the user 5A can easily grasp a relationship among a plurality of second users.

This concludes descriptions of the embodiments of this disclosure. However, the descriptions of the embodiments are not to be read as a restrictive interpretation of the technical scope of this disclosure. The embodiments are merely given as an example, and it is to be understood by a person skilled in the art that various modifications can be made to the embodiments within the scope of this disclosure set forth in the appended claims. The technical scope of this disclosure is to be defined based on the scope of this disclosure set forth in the appended claims and an equivalent scope thereof.

For example, in the second example of effect control, when a predetermined relationship (e.g., state of being close to one another in a predetermined range) is satisfied among three or more second avatar objects, the processor 210 may determine an effect image to be associated with three or more second avatar objects based on the combination of emotions of those three or more second avatar objects. For example, when the emotion types of the plurality of second users associated with the plurality of second avatar objects satisfying a predetermined relationship match each other, an effect image corresponding to the emotion type may be arranged in the field-of-view image based on the degree corresponding to the number of second users. For example, when the emotion types (e.g., “excitement”) of the plurality of users associated with the plurality of second avatar objects gathering in a hall of a concert held by a singer in the virtual space 11 match each other, an effect image corresponding to “excitement” may be displayed based on the degree corresponding to the number of second users. In this manner, it is possible to effectively exhibit the degree of excitement in the virtual space 11 in the field-of-view image M by representing the degrees of excitement of the plurality of second users as an effect image.

Distribution of functions to be executed by each HMD set 110 and the server 600 in order to implement a VR chat is not limited to the above-mentioned example, but various distribution configurations may be employed. For example, in the example described above, a description is given of the configuration of the HMD set 110, which transmits player information, generating emotion data representing the emotion of the user who uses the own system. However, the plurality of HMD sets 110 are not required to be configured to perform processing of sharing emotion data on each user in the manner described above. For example, the HMD set 110, which receives player information, may generate emotion data based on face tracking data or voice data contained in the received player information. In this case, emotion data is not required to be contained in the player information, and thus the data communication amount involving transmission/reception of player information may be reduced.

A part or all of the functions to be executed by the computer 200 of each HMD set 110 described above may be integrated into the server 600. For example, as described below, the server 600 may be configured to execute processing of generating and outputting the field-of-view image, and each HMD 120 may be configured to display the field-of-view image received from the server 600. That is, the server 600 holds data (e.g., space information 1431 and object information 1432) defining the virtual space 11 shared by the plurality of HMDs 120. The HMD sensor 410 of each HMD 120 transmits information on the position and inclination of the HMD 120 to the server 600. The server 600 generates a field-of-view image that depends on the position and inclination of each HMD 120, and transmits field-of-view image data for displaying the field-of-view image to each HMD 120. In this case, for example, the entity that executes the processing of, for example, Step S1110 and Step S1180 of FIG. 11 described above is the server 600. Functions (e.g., synchronization processing described later) of the server 600 in this embodiment may be implemented by the computer 200.

The subject matter disclosed herein is represented as, for example, the following Items.

(Item 1)

An information processing method to be executed by a computer 200 to provide a first user (user 5A) with a virtual space 11 via a first head-mounted display (HMD 120A), the information processing method including:

a step (Step S1110 of FIG. 11) of generating virtual space data for defining the virtual space 11 including a first avatar object (avatar object 6A) associated with the first user, a second avatar object (avatar object 6B or 6C) associated with a second user (user 5B or 5C), and a virtual camera 14 for defining a field-of-view image 17 to be provided to the first head-mounted display;

a step (e.g., Step S1810 of FIG. 18) of identifying an emotion of the second user;

a step (e.g., Step S1820 of FIG. 18) of determining an effect image to be displayed in association with the second avatar object in the field-of-view image based on the identified emotion of the second user; and

a step (e.g., Step S1850 of FIG. 18) of arranging the determined effect image in the field-of-view image.

According to the information processing method of this item, it is possible to allow the first user to easily grasp an emotion of the second user by arranging the effect image in the field-of-view image. As a result, it is possible to facilitate emotional understanding among the users in the virtual space 11.

(Item 2)

An information processing method according to Item 1, in which the step of identifying an emotion includes identifying the emotion of the second user based on at least one of a facial expression and a voice of the second user.

According to the information processing method of this item, it is possible to appropriately identify the emotion of the second user based on the facial expression and the voice of the second user.

(Item 3)

An information processing method according to Item 1 or 2,

in which the step of identifying an emotion includes identifying an emotion degree of the second user, and

in which the step of determining an effect image includes determining a mode of display of the effect image based on the identified emotion degree of the second user.

According to the information processing method of this item, the first user can visually grasp the emotion degree of the second user by the mode of display of the effect image.

(Item 4)

An information processing method according to any one of Items 1 to 3,

in which the virtual space includes the plurality of second avatar objects associated with the plurality of second users, respectively, and

in which the step of determining an effect image includes determining the effect image based on a combination of emotions of the plurality of second users when a predetermined relationship is satisfied among the plurality of second avatar objects.

According to the information processing method of this item, it is possible to arrange in the field-of-view image the effect image, which is synchronized with the emotions of the plurality of second users directed to each other. With this, the first user can easily grasp a relationship among the plurality of second users.

(Item 5)

An information processing method according to any one of Items 1 to 4, further including a step of generating motion data for specifying motion of a face part of the second avatar object in the field-of-view image; and

in which the step of arranging the determined effect image includes a step of arranging the effect image in synchronization with motion of the face part of the second avatar object that is based on the motion data.

According to the information processing method of this item, the first user can effectively grasp the emotion of the second user by both of change in facial expression of the second avatar object and the effect image.

(Item 6)

An information processing method according to Item 5, in which the step of generating motion data includes acquiring an image recognition result of a face image of the second user and generating the motion data based on the image recognition result.

According to the information processing method of this item, it is possible to accurately generate the motion data for representing a facial expression of the second user based on the image recognition result of the face image.

(Item 7)

An information processing method according to Item 5, in which the step of generating motion data includes:

acquiring a first facial expression image corresponding to an emotion of the second user, which has been previously identified, and a second facial expression image corresponding to an emotion of the second user, which has been currently identified, from among facial expression images of the second avatar object prepared in advance; and

generating, as the motion data, a video image for representing a change from the first facial expression image to the second facial expression image based on the first facial expression image and the second facial expression image.

According to the information processing method of this item, it is possible to represent a natural change in facial expression of the second avatar object based on the two facial expression images before and after the change in facial expression of the second avatar object. As a result, it is possible to provide the first user with a higher sense of immersion in the virtual space 11. Further, it is possible to reduce the data communication amount required for representing the change in facial expression of the second avatar object.

(Item 8)

A program for executing the information processing method of any one of Items 1 to 7 on a computer.

(Item 9)

A device, comprising:

a memory having stored thereon the program of Item 8; and

a processor, which is coupled to the memory, and is configured to execute the program.

1. A method, comprising the steps of:
defining a virtual space, the virtual space including a first avatar object associated with a first user, a second avatar object associated with a second user, and a virtual camera for defining a field-of-view image associated with the first avatar object;
identifying an emotion of the second user;
determining an effect image to be associated with the second avatar object based on the identified emotion of the second user; and
arranging the determined effect image in the field-of-view image.

2. A method according to claim 1, further comprising a step of identifying at least one of a facial expression and a voice of the second user,
wherein the step of identifying an emotion includes identifying the emotion of the second user based on the identified at least one of the facial expression and the voice.

3. A method according to claim 1,
wherein the step of identifying an emotion includes further identifying an emotion degree of the second user,
wherein the step of determining an effect image includes determining a mode of display of the effect image based on the identified emotion degree of the second user, and
wherein the step of arranging the determined effect image includes arranging the determined effect image in the determined mode of display.

4. A method according to claim 1,
wherein the virtual space includes the plurality of second avatar objects associated with the plurality of second users, respectively,
wherein the method further comprises the steps of:
defining a first relationship; and
determining whether the first relationship is satisfied among the plurality of second avatar objects, and
wherein the step of determining an effect image includes determining, in response to satisfaction of the first relationship, the effect image based on a combination of respective emotions of the plurality of second users satisfying the first relationship.

5. A method according to claim 1, further comprising the steps of:
generating motion data for specifying motion of a face of the second avatar object; and
moving the face based on the motion data,
wherein the step of arranging the determined effect image includes arranging the determined effect image so that the determined effect image follows the motion of the face.

6. A program for executing the method of claim 1 on a computer.

7. A device, comprising:
a memory having stored thereon the program of claim 8; and
a processor, which is coupled to the memory, and is configured to execute the program.
